(19) United States
(12) Patent Application Publication
(10) Pub. No.: US 2024/0303259 A1
(43) Pub. Date: Sep. 12, 2024

(54) IMITATING ANALYST'S CONTENT CATEGORIZATION WITH AUTOMATIC QUESTION ANSWERING

(71) Applicant: International Business Machines Corporation, Armonk, NY (US)

(72) Inventors: Anton Puzanov, Mitzpe Ramon (IL); Yair Allouche, Mitzpe Ramon (IL); Eitan Menahem, Negev Beer Sheva (IL)

(21) Appl. No.: 18/119,504

(22) Filed: Mar. 9, 2023

(51) Int. Cl. G06F 16/332; G06F 16/33; G06F 16/35

(52) U.S. Cl. CPC G06F 16/3329; G06F 16/3347; G06F 16/35

(57) ABSTRACT

A document categorization method, system, and computer program product that includes forming a corpus of categorized documents by relying on a manual classification of a subject matter expert, composing a bank of questions, and answering each question automatically using a question answering language model with respect to each document and generating a set of features for each document.

### BACKGROUND

The present invention relates generally to a document categorization method, and more particularly, but not by way of limitation, to a system, method, and computer program product for automatic document categorization using natural language models by modeling domain expertise as a series of questions, document categories include but are not limited to MITRE® tactics and techniques.

In recent years, a tremendous effort has been put into sharing cybersecurity knowledge. At first, each contributor used a proprietary categorization terminology, which made knowledge-fusion practically impossible. This paved the way to forming categories and topics related to the domain. The process of categorization of cyber-related content is sometimes called “threat modeling”.

Content categorization has significant business impact as it allows an organization to quickly launch security products by relying on publicly-available, high-quality knowledge bases. On top of that, such products are quickly adopted by analysts and integrated with other platforms due to the standard language used by them. Cyber protection tools may automatically extract mitigation and recommendation suggestions with respect to known threat-types. There are many additional benefits of categorization, such as quick content updates from the community, improved explainability and user experience (UX), variety of integrations and others.

Conventionally, various categories have been suggested, covering a large variety of cybersecurity aspects. Equally important, a significant effort has been made in creating a mapping between various categorizations.

However, content categorization is a difficult task, it is exhausting manual work and usually relies on cybersecurity experts and their domain knowledge.

Thereby, there is a technical problem in the art that a technique to offload content categorization from manual work of human analysts to an automated process is not a solved problem.

### SUMMARY

In view of the above-mentioned problems in the art, the inventors have considered a technical solution to the technical problem in the conventional techniques by providing a technique for automatic content categorization that employs the advancements in Natural Language Processing (NLP) and Natural Language Understanding (NLU), specifically in the field of Question and Answer (Q&A), to imitate the interaction that a human analyst would have with the document in question, by looking at the domain knowledge as a series of questions.

Thereby, the invention provides a technical solution where automatic threat modeling helps organizations to reduce operation costs and to help with skill shortage by automating part of the threat modeling workload.

In an exemplary embodiment, the present invention can provide a computer-implemented document categorization method, the method including forming a corpus of categorized documents by relying on manual classification of subject matter experts, composing a bank of questions, and answering each question automatically using a question answering language model with respect to each document and generating a set of features for each document.

In another exemplary embodiment, the present invention can provide a document categorization computer program product, the document categorization computer program product comprising a computer-readable storage medium having program instructions embodied therewith, the program instructions executable by a computer to cause the computer to perform: forming a corpus of categorized documents by relying on manual classification of subject matter experts, composing a bank of questions, and answering each question automatically using a question answering language model with respect to each document and generating a set of features for each document.

In another exemplary embodiment, the present invention can provide a document categorization system, said document categorization system including a processor, and a memory, the memory storing instructions to cause the processor to perform: forming a corpus of categorized documents by relying on manual classification of subject matter experts, composing a bank of questions, and answering each question automatically using a question answering language model with respect to each document and generating a set of features for each document.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings.

Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes (and others) of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 depicts a computing environment 100 according to an embodiment of the present invention;

FIG. 2 exemplarily shows a high-level flow chart for a document categorization method 200 according to an embodiment of the present invention;

FIG. 3 exemplarily depicts a general scheme for the training phase of the content categorization according to an embodiment of the present invention;

FIG. 4 exemplarily depicts a general scheme for the classification phase of the threat categorization according to an embodiment of the present invention; and

FIG. 5 exemplarily depicts a general scheme for the classification phase of the iterative method according to an embodiment of the present invention.

### DETAILED DESCRIPTION

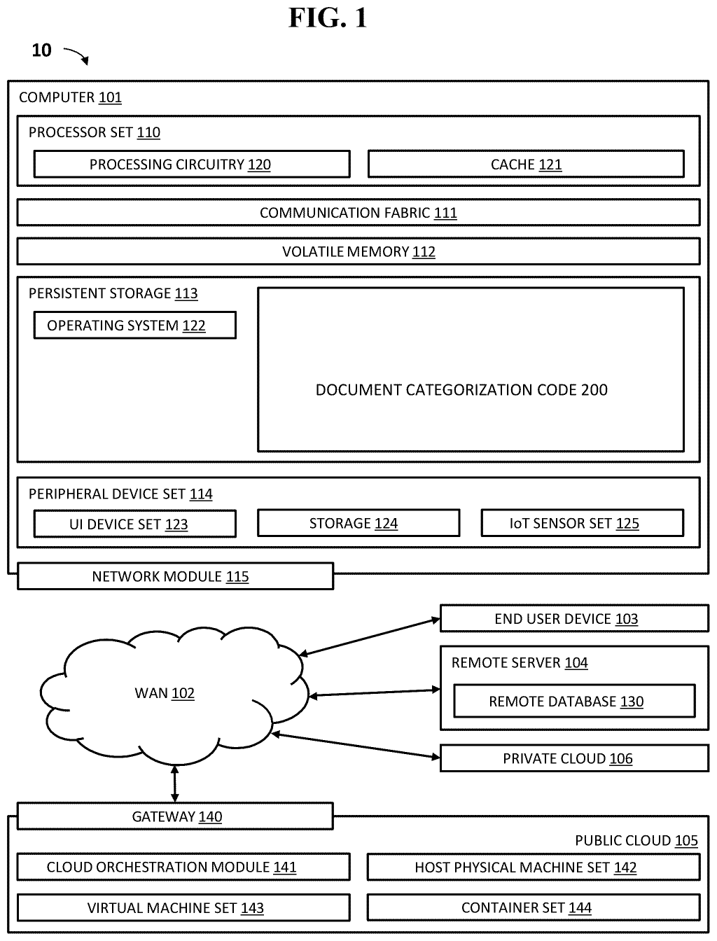

The invention will now be described with reference to FIGS. 1-5, in which like reference numerals refer to like parts throughout. It is emphasized that, according to common practice, the various features of the drawing are not necessarily to scale. On the contrary, the dimensions of the various features can be arbitrarily expanded or reduced for clarity.

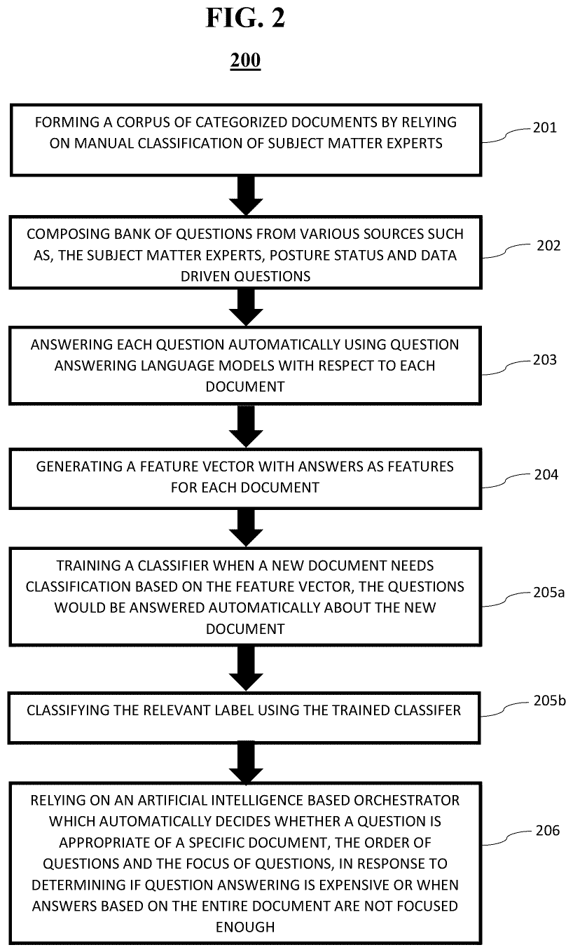

With reference now to the exemplary method 200 depicted in FIG. 2, the invention includes various steps for a system that automatically answers questions (e.g., not relying on the user as in the submission) and encode the analyst knowledge which makes a big impact on the ability to correctly classify.

The document categorization method 200 according to an embodiment of the present invention may act in a more sophisticated, useful and cognitive manner, giving the impression of cognitive mental abilities and processes related to knowledge, attention, memory, judgment and evaluation, reasoning, and advanced computation. A system can be said to be “cognitive” if it possesses macro-scale properties—perception, goal-oriented behavior, learning/memory and action—that characterize systems (i.e., humans) generally recognized as cognitive.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

With reference generally to FIGS. 1-5, in the cybersecurity domain, subject matter expertise presents a key differentiator between the accuracy of a subject matter expert (SME) and a simple classifier. The invention disclosed herein includes a way of encoding the expertise and automatically applying it on a task at hand. This significantly affects classification accuracy and is a major advancement of the approach. Often Q&A systems are expensive or limited, in that case the inventive iterative approach disclosed herein better utilizes the available resources, which translates to the ability to classify more samples and reduce operation costs. On top of that, the approach herein handles situations when different answers are relevant to different portions of the document, and each portion represents a different category, this also improves accuracy. And, the benefit of relying on the questions originated from the SMEs themselves is the confidence, having answers as features allows to easily explain the reasoning behind decisions and positively affect confidence and calibration.

With specific reference to FIG. 2, in step 201, a corpus of categorized documents is formed by relying on manual classification of subject matter experts. In other words, step 201 may be considered the training phase.

In step 202, a bank of questions is composed from various sources such as the subject matter experts, posture status, and/or data-driven questions.

In step 203, each question is automatically answered using question answering language models with respect to each document, and a feature vector is generated with answers as features for each document in step 104.

In step 205a and step 205b, a classifier is trained when a new document needs classification based on the feature vector, the questions would be answered automatically about it, and the classifier classifies the relevant label.

And, in step 206, automatically deciding, by relying on an artificial intelligence (AI)-based orchestrator, whether a question is appropriate of a specific document, the order of questions and the focus of questions, in response to determining if question answering is expensive or when answers based on the entire document are not focused enough.

Thus, the invention of method 200 includes a novel approach for content categorization which combines question answering and classification to imitate the inference and decision making of a human analyst.

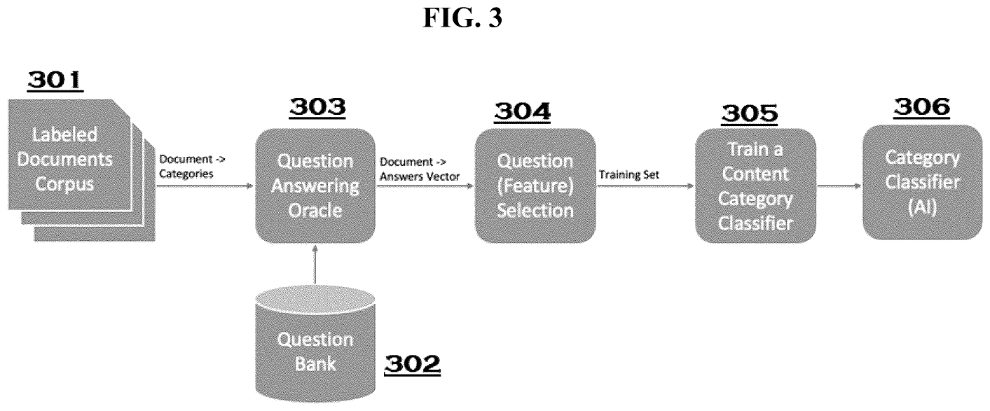

With reference to FIGS. 3-5, the general scheme for threat modeling is composed of a training phase and classification (online) phase.

As shown in FIG. 3, the training phase trains a supervised classification model for categorization. Given a corpus of labeled documents and a questions bank, a Q&A oracle is invoked to answer each question with respect to each document. Here, the questions serve as features and the vector of answers would be a feature vector.

With regard to the labeled document corpus 301, as mentioned earlier, categorization is applied on various content. Thus, the documents corpus and categories are related to the application in question. Each document should have corresponding labels for training. Some examples for documents are shown in TABLE 1 below reporting new threats seen on the wild and MITRE® Tactic categories. It is noted that only the title is presented here for brevity, and it is assumed that the document body has more details regarding the topic. Each document maps to zero, one or more than one category.

TABLE 1

| Document Title | Related MITRE ® Tactics |
|---|---|
| A Deep Dive Into The Ragnar Locker | Reconnaissance, Impact |
| Gang | |
| BlackMatter Ransomware Analysis | Privilege Escalation |

With regard to the question bank 302, the question bank 302 acts as the feature space for the classification problem. A purpose of the question bank 302 is to hold hints for the relevant pieces of information required to correctly classify a document. Question resources include, but are not limited to, (a) questions from SMEs (e.g. analysts), (b) posture questions (e.g., which OS is relevant for the document? is Windows OS affected by the document is question? was a connection established? Etc.), which are those questions that could be automatically generated by using a domain-specific Named Entity Recognition (NER), and/or (c) Data-driven inference such as document topic discovered with topic modeling NLP algorithms, etc.

Regarding the question answering oracle 303, the question answering oracle 303 supports the human level understanding of the content. The oracle's purpose is to answer the questions from the question bank with respect to one or more documents. The solution does not rely on a single oracle, but rather picks the most appropriate oracle for the question. Some of the question types that the oracles can support are extractive—where the oracle would accept a context and question and find the relevant answer in the context or generative—where the oracle would generate a free text answer by looking at a context and a question.

Although the oracle may consider a single document at a time, the inventive approach can utilize a retriever thus handling a collection of documents. In that case, the retriever would filter the relevant documents before feeding them to the oracle.

The Q&A oracles 303 can be implemented as a complex neural network(s) (NN). When dealing with specific domains, it is usually beneficial to pre-train the models with a corpus of data from the domain.

Regarding the question (feature) selection 304, feature selection is a standard task in classifier training as it is used to limit the number of features that the model relies on with minimal performance penalties, thus resulting in lighter models with similar results. In the invention disclosed herein, feature selection dramatically affects execution time as each feature is calculated by passing a question through a complex neural network. As this step is highly application-dependent, two approaches are suggested as an example, but any other feature selection approach could fit. The two approaches include low variance feature removal and model-based feature importance.

Regarding training the content categorization classifier 305, after obtaining a feature vector with answers as features, the next step is to train a supervised model using the answers and target labels. That step is also very application-dependent and is considered a standard one in a machine learning (ML) pipeline. Thus, the invention is not limited to a specific model and any model could work for some problem.

The result of the training phase is the trained model and the most prominent questions (i.e., the category classifier 306).

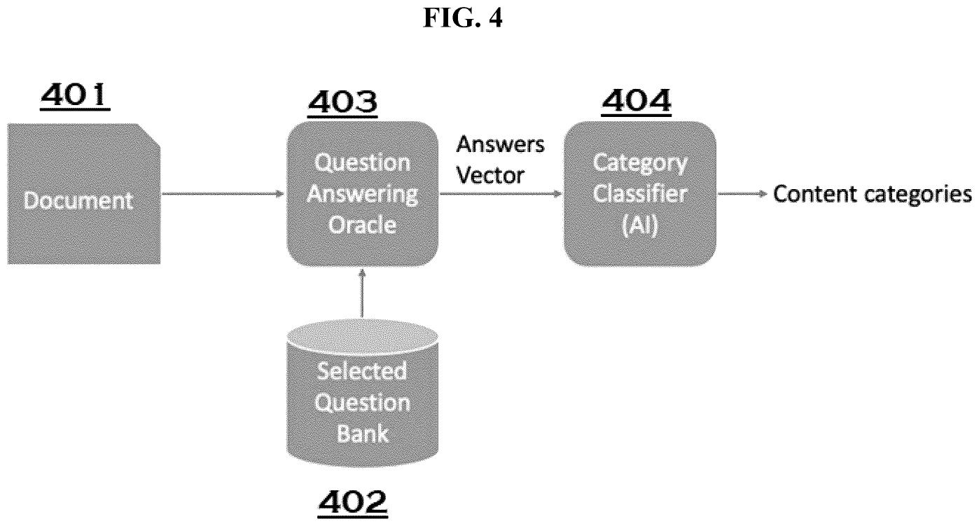

With reference now to FIG. 4, FIG. 4 exemplarily depicts a general scheme for the classification phase of the threat categorization. The classification phase of the content categorization is based on three main components including a selected question(s) bank 402, a question answering oracle 403 and a classification model 404 for a document 401.

With regard to the selected question bank 402, the selected question bank 402 is composed out of the most informative questions for threat modeling, as were selected in the question (feature) selection phase of the training phase.

For the question answering oracle 403, this is the same oracle as the one used for the training phase (i.e., question answering oracle 303). The question answering oracle 403 produces the answers vector with respect to each document and questions, generating the exact same vector structure as was used to train the classifier.

And, the classification model 404 (i.e., category classifier (AI)) is the classifier obtained as the output from the training phase.

Overall, the online phase as shown in FIG. 4 is about taking the document in question and applying the model from the training phase on it. The output is the target class according to the data used to train the model. Prominent examples are threat model categories such as MITRE ATT&CK®, decisions such as block/no block for a machine, event topics (e.g., authentication or malware) and many other classification tasks relevant to the cybersecurity domain.

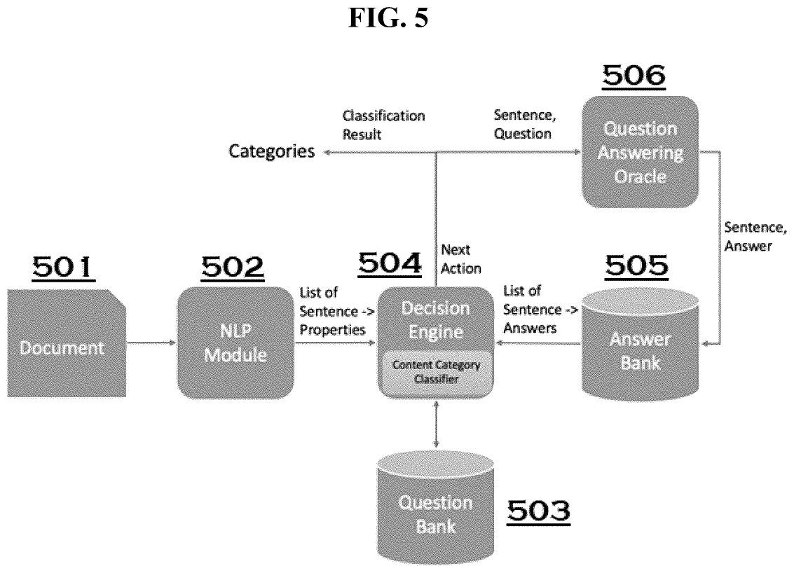

With regard to FIG. 5, FIG. 5 exemplarily depicts a general scheme for the classification phase of the iterative method. Question answering is an expensive operation, either in terms of computation power or usage costs in a pay-per-use deployment. Answers based on the entire document are not focused enough, as there is no way to identify whether two features relate to the same context or not (e.g., whether features relate to the same context or paragraph). To solve those limitations, a method involving an AI Orchestrator is suggested as shown in FIG. 5.

The iterative method focuses on document sections while also limiting the number of asked question to a minimum. After each Q&A iteration, the overall knowledge is evaluated by the decision engine 504, and two outputs are simultaneously generated, the first is the classification, and the second is the next question-which has the shape of a context and the question. This approach is based on five main components (NLP module 502, decision engine 504, question bank 503, answer bank 505, and question answering oracle 506), the interconnection between them and the general workflow of the iterative approach are listed next.

With reference to the NLP module 502, each document 501 in question would be partitioned into sections (e.g., by considering paragraphs, context or any other method from the NLP domain). On top of that, any other relevant context would be extracted (e.g., named entities, topics, etc.).

The content category classifier of the decision engine 504 is similar to the classifier 306. To improve performance, the classifier could be trained with partial features (e.g., 20% of the features would have values and the others would be set to “unknown”).

With reference now to the decision engine 504, at each step the engine 504 considers the sentence sections from the NLP module 502, the suggested classification probabilities for them generated by the threat modeling classifier and the remaining questions. The decision engine 404 suggests the next step in terms of section text and zero or more questions.

Zero questions means that the decision is final, while any number of questions means more exploration is possible. Note that the classification is available at any iteration, and it would get more accurate as more questions are asked.

The decision engine 504 can be as simple as a rule-based system of a complex artificial intelligence (AI) agent. Due to the various number of parameters such as different labels, various questions, costs and computation times, the inventors suggest training a Reinforcement Learning (RL)-based agent. The agent would automatically consider all parameters with respect to a target function and would generate the best matching action.

The question answering oracle 506 is similar to the oracle 303 of FIG. 3.

With reference to the question bank 503 and answer bank 505, the selected questions bank relies on the same sources as FIG. 3 and can be filtered with feature selection. As the querying of the oracle is iterative, each answer is aggregated in answers bank 505.

Thereby, the answers in the inventive approach disclosed herein are used for classification (i.e., not generated by the classification). This leads to better modeling of the domain, higher accuracy and better confidence by the end-user. Also, the answers are generated automatically with content, and this makes the system much more versatile-allowing it to support new question(s) and a variety of documents by design. And, the language model extracts results based on encoded domain knowledge, leading to better modeling the domain, higher accuracy and better confidence by the end user.

Indeed, at a high-level, in order to classify a document, a bank of questions is composed by the invention from various sources including: subject matter experts, posture status and/or data driven questions. Those questions are answered automatically using question answering language models with respect to each document, generating a set of features for each document. The invention includes system training that relies on a set of labeled documents with answered questions for each documents. This corpus acts as a training set.

The training set is used to train a classifier, when a new document needs classification, the questions would be answered automatically about it, and the classifier would classify the relevant label. When question answering is expensive or when answers based on the entire document are not focused enough, a conservative approach is more appropriate. In those cases, the inventors suggest relying on an AI-based orchestrator which automatically decides whether a question is appropriate for/or a specific document, the order of questions and the focus of questions.

### Exemplary Aspects, Using a Computing Environment

With reference now to FIG. 1, computing environment 100 contains an example of an environment for the execution of at least some of the computer code involved in performing the inventive methods, such as document categorization code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented document categorization method, the method comprising:
forming a corpus of categorized documents by relying on a manual classification of a subject matter expert;
composing a bank of questions; and
answering each question automatically using a question answering language model with respect to each document and generating a feature vector with answers as features for each document.

2. The computer-implemented document categorization method of claim 1, further comprising, during a training phase:
after obtaining the feature vector with answers as the features, training a category classifier using the answers and target labels.

3. The computer-implemented document categorization method of claim 2, further comprising, during an online phase:
applying the trained category classifier to an input document to output a target class according to data used to train the category classifier.

4. The computer-implemented document categorization method of claim 3, further comprising running a decision engine that, at each step during the online phase, considers:
sentence sections from a natural language processing module that partitions each document into sections; and
suggested classification probabilities for the sentence sections generated,
wherein the decision engine suggests a next step in terms of section text and zero or more questions.

5. The computer-implemented document categorization method of claim 4, wherein the decision engine includes a rule-based system of a complex artificial intelligence (AI) agent.

6. The computer-implemented document categorization method of claim 1, wherein the categorizing focuses on MITRE® tactics and techniques.

7. The computer-implemented document categorization method of claim 1, further comprising relying on an artificial intelligence (AI)-based orchestrator which automatically decides whether a question is appropriate for a specific document and an order of questions and a focus of questions to moderate the classification.

8. The computer-implemented document categorization method of claim 1, embodied in a cloud-computing environment.

9. A document categorization computer program product, the document categorization computer program product comprising a computer-readable storage medium having program instructions embodied therewith, the program instructions executable by a computer to cause the computer to perform:
forming a corpus of categorized documents by relying on a manual classification of a subject matter expert;
composing a bank of questions; and
answering each question automatically using a question answering language model with respect to each document and generating a set of features for each document.

10. The computer program product of claim 9, further comprising, during a training phase:
after obtaining the feature vector with answers as the features, training a category classifier using the answers and target labels.

11. The computer program product of claim 10, further comprising, during an online phase:
applying the trained category classifier to an input document to output a target class according to data used to train the category classifier.

12. The computer program product of claim 11, further comprising running a decision engine that, at each step during the online phase, considers:
sentence sections from a natural language processing module that partitions each document into sections; and
suggested classification probabilities for the sentence sections generated,
wherein the decision engine suggests a next step in terms of section text and zero or more questions.

13. The computer program product of claim 12, wherein the decision engine includes a rule-based system of a complex artificial intelligence (AI) agent.

14. The computer program product of claim 9, wherein the categorizing focuses on MITRE® tactics and techniques.

15. The computer program product of claim 9, further comprising relying on an artificial intelligence (AI)-based orchestrator which automatically decides whether a question is appropriate for a specific document and an order of questions and a focus of questions to moderate the classification.

16. A document categorization system, said document categorization system comprising:
a processor; and
a memory, the memory storing instructions to cause the processor to perform:
forming a corpus of categorized documents by relying on a manual classification of a subject matter expert;
composing a bank of questions; and
answering each question automatically using a question answering language model with respect to each document and generating a set of features for each document.

17. The document categorization system of claim 16, further comprising, during a training phase:
after obtaining the feature vector with answers as the features, training a category classifier using the answers and target labels.

18. The document categorization system of claim 17, further comprising, during an online phase:
applying the trained category classifier to an input document to output a target class according to data used to train the category classifier.

19. The document categorization system of claim 16, further comprising running a decision engine that, at each step during the online phase, considers:
sentence sections from a natural language processing module that partitions each document into sections; and
suggested classification probabilities for the sentence sections generated,
wherein the decision engine suggests a next step in terms of section text and zero or more questions.

20. The document categorization system of claim 16, embodied in a cloud-computing environment.
